(19) United States
(12) Patent Application Publication
(10) Pub. No.: US 2006/0188323 A1
(43) Pub. Date: Aug. 24, 2006

(54) Rail and railing system

(76) Inventor: Simon Walker, White Rock (CA)

Correspondence Address: PEAK INNOVATIONS INC.;ATTN: LEGAL DEPARTMENT, 11782 HAMMERSMITH WAY, SUITE 203, RICHMOND, BC, V7A-3E2, CA

(21) Appl. No.: 10/547,183

(22) PCT Filed: Mar. 11, 2004
(86) PCT No.: PCT/CA04/00378

§ 371 Date: Aug. 29, 2005

(30) Foreign Application Priority Data
Mar. 12, 2003 (CA) 2,422,750

(51) Int. Cl. E04B 1/19; B25G 3/00

(52) U.S. Cl. 403/19

(57) ABSTRACT

The invention concerns a rail (12;14) for a railing system having a plurality of spacers (20) for spacing a plurality of railing pickets, said rail comprising a substantially elongated planar member (22) and first and second substantially parallel elongated side-walls (24, 26) perpendicularly connected to said planar member (22), wherein said side walls each comprise opposing grooves (28) running substantially parallel to said elongated planar member (22), said grooves adapted to receive the plurality of spacers (20). The invention concerns also a railing system for holding picket railings and comprising a plurality of spacers (20) adapted to space the picket railings apart and a rail adapted to internally receive said plurality of spacers and to secure the picket railings.

### FIELD OF THE INVENTION

The invention relates to the field of railings and in particular to an aluminum rail and railing system.

### BACKGROUND OF THE INVENTION

Railing systems for any number of outdoor applications are well known. For example, residential decks, pool decks, playgrounds, etc., all utilize any number of conventional railing systems. Such railing systems are typically made of pressure treated lumber or aluminum particularly suited for outdoor use.

Typically, aluminum railing systems utilize spacers which snap onto top and bottom rails to space out railing pickets. Although such systems adequately space out the pickets, the overall appearance of the system is less than desired given that the spacers necessary protrude away from the railings. Furthermore, as the spacers merely snap onto the top and bottom rails, the spacers are susceptible to removal after the railing system has been assembled. Consequently, thieves may easily remove the spacers leaving the railing system vulnerable to failure. These systems are undesirable, particularly in the residential railing industry wherein homeowners frequently install or build their own rail systems.

Accordingly, a need exists for an improved rail and railing system which provides an aesthetically pleasing result and which overcomes the deficiencies noted above.

### SUMMARY OF THE INVENTION

According to one aspect of the present invention there is provided a rail for a picket railing system having a plurality of spacers for spacing a plurality of railing pickets. The rail may include a substantially elongated planar member and first and second substantially parallel elongated side-walls perpendicularly connected to the planar member. The side walls may each comprise opposing grooves running substantially parallel to the elongated planar member. The grooves may be adapted to receive the plurality of spacers and may be formed within each of the side walls.

Each of the grooves may comprise a first elongated groove member and a second elongated groove member. The first elongated groove member may be connected adjacent an end of the side wall and extend perpendicularly from the side-wall. The second elongated groove member may be connected adjacent the end of said side wall and run parallel to the first groove member. The second elongated groove member may be spaced away from the first elongated groove member to permit snugly insertion of the plurality of spacers between the first and second groove members.

According to another aspect of the invention there is provided a rail system for holding picket railings. The rail system may include a plurality of spacers adapted to space the picket railings apart and a rail adapted to internally receive the plurality of spacers and to secure the picket railings.

Each of the plurality of spacers may include a top member and first and second parallel wings connected to the top member. The first and second wings may be shaped to be received in grooves located within the railings.

According to yet another aspect of the invention there is provided a rail system which includes a top rail and bottom rail, a post adapted to receive the top and bottom rails, a plurality of pickets for placement between the top and bottom rails, and a plurality of spacers adapted to be inserted into the top and bottom rails for spacing the plurality of pickets apart.

The post may include an open ended head to receive the top rail and an opening for receiving the bottom rail. Alternatively, the post may include connectors to receive the top and bottom rails. The connectors may include universal angle brackets. The post may also include post supports.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is a perspective view of a rail and railing system made in accordance with a first embodiment of the present invention;

FIG. 2 is a perspective view of a section of top and bottom rails with representative spacers of the railing system of FIG. 1;

FIG. 3 is a cross sectional view along lines 3-3 and 3′-3′ of FIG. 1;

FIG. 4 is a perspective view of a post and a section of top and bottom rails of FIG. 1;

FIG. 5. is a perspective view of an alternative embodiment of the post of FIG. 4; and

FIG. 6. is a perspective exploded view of the railings system of FIG. 1.

### DESCRIPTION OF THE PREFERRED EMBODIMENT OF THE INVENTION

Reference will now be made in detail to the presently preferred embodiments of the invention, one or more examples of which are illustrated in the drawings. Each example is provided by way of explanation of the invention, and not meant as a limitation of the invention. For example, features illustrated or described as part of one embodiment can be used on another embodiment to yield still a third embodiment. It is intended that the present invention include such modifications and variations as come within the scope and spirit of the present invention.

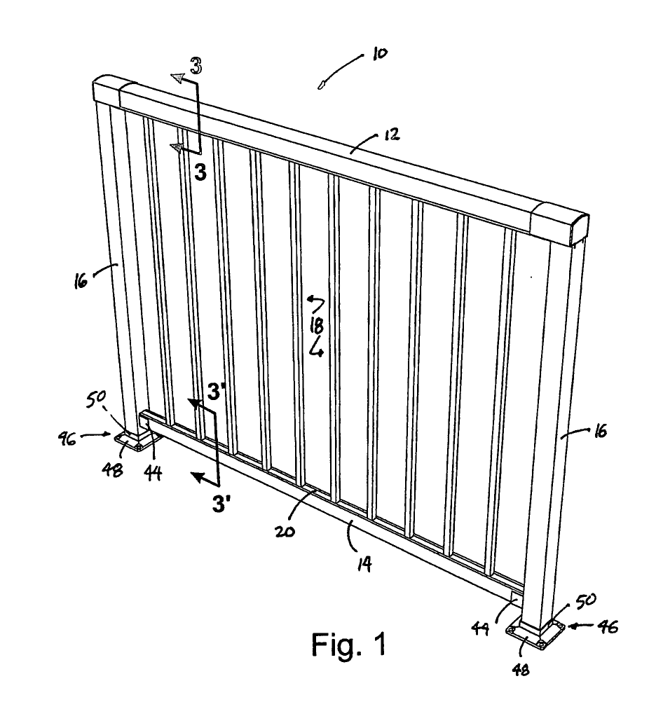

An outdoor railing system, generally 10, according to the invention is illustrated in FIG. 1. Railing system 10 is illustrated as a section of a complete rail for purposes of illustration. The present invention includes such sections as well as a complete railing system constructed in accordance with the invention. The present invention also includes top and bottom rails 12 and 14 separately for use in such railing systems.

Conventional outdoor railing systems are typically made from aluminum. The present invention includes rails and railing systems made of aluminum, but is not limited to any particular material. For example, the components of the railing system 10 or rails 12 and 14 may be fabricated from any conventional construction material, including plastic, wood, cementious materials, and the like. Any and all such materials suitable for railing systems are within the scope and spirit of the invention.

Referring again to FIG. 1, railing system 10 includes top and bottom rails 12 and 14, posts 16, pickets 18 and picket spacers 20 in between each pickets. The pickets 18 are of sufficient length to span the distance between the top and bottom rails 12 and 14.

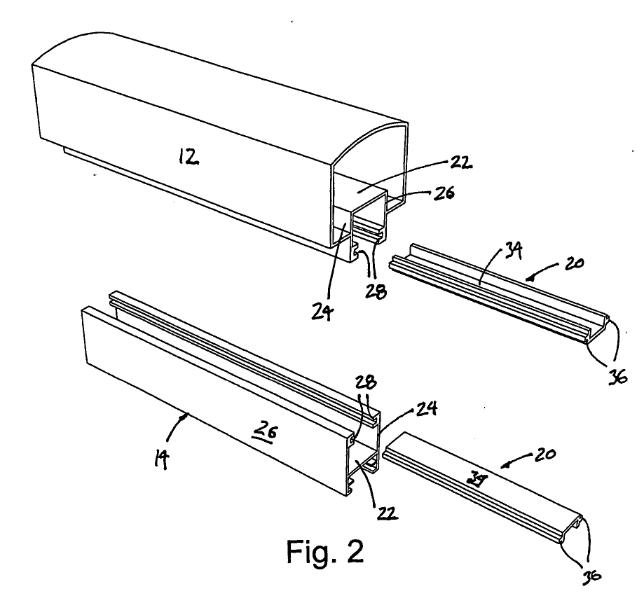

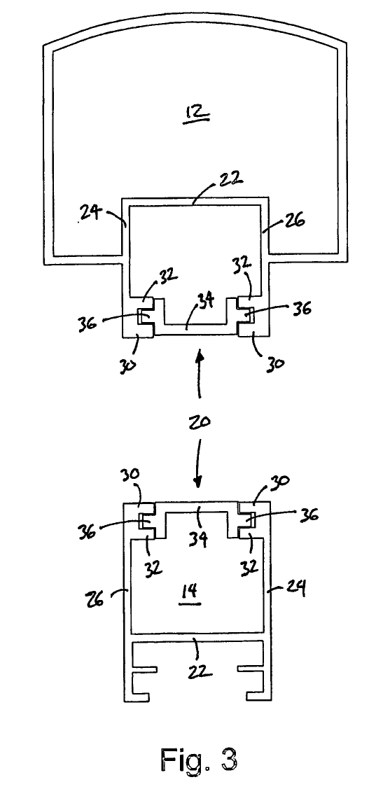

Referring to FIGS. 2 and 3, each rail includes a substantially elongated planar member 22 and first and second substantially parallel elongated side walls 24 and 26 perpendicularly connected to the planar member 22. The side walls 24 and 26 each include opposing grooves 28 running substantially parallel to the elongated planar member 22.

The grooves 28 are adapted to receive the spacers 20 and include a first elongated groove member 30 and a second elongated groove member 32. The first elongated groove member 30 is connected adjacent an end of the side walls 24 and 26 and extends perpendicularly from the side-walls 24 and 26. The second elongated groove member 32 is also connected adjacent the same end of the side walls 24 and 26 and runs parallel to the first groove member 30. The second elongated groove member 32 should be spaced away from the first elongated groove member 30 to permit snugly insertion of the spacers 20 between the first and second groove members 30 and 32.

The first and second side walls 24 and 26 may be connected to the planar member 22 via spot welding in the case of aluminum. Similarly, the first and second groove members 30 and 32 may be connected to the side walls 24 and 26 via spot welding in the case of aluminum. As those skilled in the art will appreciate other methods of connecting the first and second side walls 24 and 26 to the planar member 22 and the groove members 30 and 32 to the side walls 24 and 26 are contemplated, for example, adhesive, fasteners etc. Preferably, each of the top and bottom rails 12 and 14 is a unitary structure which may be accomplished via an aluminum extrusion for instance or by other means known in the art.

The spacers may include a top member 34 and first and second parallel wings 36 shaped to be received in the grooves 28. The first and second parallel wings 36 may be connected to the top member 34 via spot welding in the case of aluminum. As those skilled in the art will appreciate other methods of connecting the first and second wings 36 to the top member 34 are contemplated, for example, adhesive, fasteners etc. Preferably, the first and second parallel wings 36 are integrally formed with the top member 34 via an aluminum extrusion for instance or by other means known in the art.

As best shown in FIG. 3, once spacers 20 are inserted into top and bottom rails 12 and 14, the first and second parallel wings 36 abut the first and second groove members 30 and 32. In so doing, the spacers 20 snugly fit into grooves 28, thus preventing the spacers 20 from being removed from the railing system 10 after assembly. To provide for an aesthetically pleasing result, the top member 34 may be spaced away from the first and second parallel wings 36 so that the top member 34 lies flush with the first elongated groove member 30. However, in another embodiment, those skilled in the art will also appreciate that parallel wings 36 may be flush with top member 34 providing an overall flat surface.

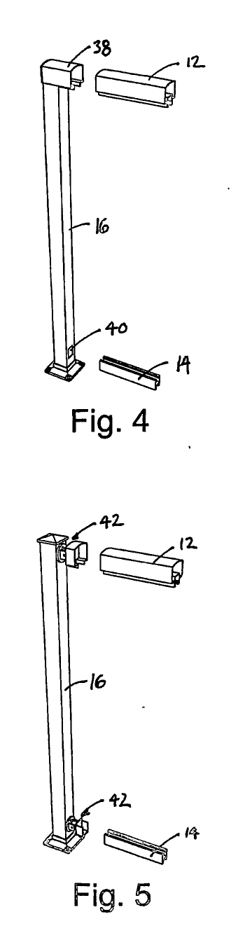

Referring to FIG. 4, the post 16 includes an open ended head 38 shaped to receive the top rail 12. In this embodiment, the post 16 may also include an opening 40 to receive the bottom rail 14. Preferably, the open ended head 38 and opening 40 are shaped to snugly fit top and bottom rails 12 and 14 to secure the top and bottom rails to the post 16. As those skilled in the art will appreciate, other methods may be used to further secure the top and bottom rails 12 and 14 to the post 16, such as fasteners.

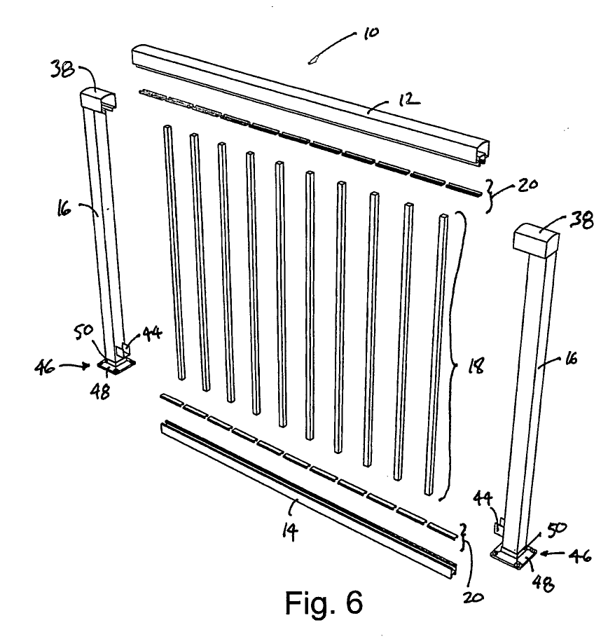

Referring to FIG. 5, in another embodiment, the post 16 includes connectors to receive the top and bottom rails 12 and 14. The connectors comprise universal angle brackets 42 as known to those skilled in the art. Universal angle brackets are particularly useful for railing applications requiring non-conventional angles, such as following a flight of steps. Alternatively, the connectors may simply be a U-bracket 44 as illustrated in FIGS. 1 and 6. As those skilled in the art will appreciate, several connectors are contemplated and may be used in different combinations for use with the top and bottom rails 12 and 14 without varying the scope and spirit of the present invention.

As best illustrated in FIGS. 1 and 6, to provide additional support to the posts 16, the posts may include post supports 46. Preferably, the post supports 46 include a base 48 which can be connected to a deck surface for instance. A sleeve 50 may be attached to the base 48 to snugly receive the posts 16. The post supports 46 may be separately fabricated and attached to the posts 16 during installation of the railing system or may be integrally fabricated with the posts.

Operation

The top and bottom rails 12 and 14 are connected to a post 16. At least one spacer 20 is inserted into each of the top and bottom rails 12 and 14. A picket 18 may then be installed between the top and bottom rails 12 and 14 by simply placing the ends of the pickets into the top and bottom rails and abutting the picket next to the spacer 20. Further spacers 20 and pickets 18 may be inserted until a desired number of pickets has been installed. A second post 16 may then be connected to the top and bottom rails 12 and 14 to complete the assembly resulting in an aesthetically pleasing and secure railing system. Alternatively, the top and bottom rails 12 and 14 may first be attached to a wall without the need for a first post 16 and then assembled as discussed above.

It should be appreciated by those skilled in the art that various modifications and variations can be made in the present invention without departing from the scope or spirit of the invention. It is intended that the present invention include such modifications and variations as come within the scope of the appended claims and their equivalents.

What is claimed is:

1. A rail for a railing system having a plurality of spacers for spacing a plurality of railing pickets, the rail comprising:
a substantially elongated planar member; and
first and second substantially parallel elongated side-walls perpendicularly connected to said planar member wherein said side walls each comprise opposing grooves running substantially parallel to said elongated planar member, said grooves adapted to receive the plurality of spacers.

2. The rail of claim 1 wherein each of said grooves comprises a first elongated groove member and a second elongated groove member, said first elongated groove member being connected adjacent an end of said side wall and extending perpendicularly from said side-wall, said second elongated groove member being connected adjacent said end of said side wall and running parallel to said first groove member and spaced away from said first elongated groove member to permit snugly insertion of the plurality of spacers between said first and second groove members.

3. The rail of claim 1 wherein each of said grooves is formed within each of said side walls.

4. A rail system for holding picket railings, the rail system comprising:
a plurality of spacers adapted to space the picket railings apart; and
a rail adapted to internally receive said plurality of spacers and to secure the picket railings.

5. The rail system of claim 4 wherein said rail comprises:
a substantially elongated planar member, and
first and second substantially parallel elongated side-walls perpendicularly connected to said planar member wherein said side walls each comprise opposing grooves running substantially parallel to said elongated planar member, said grooves adapted to receive the plurality of spacers.

6. The rail of claim 5 wherein each of said grooves comprises a first elongated groove member and a second elongated groove member, said first elongated groove member being connected adjacent an end of said side wall and extending perpendicularly from said side-wall, said second elongated groove member being connected adjacent said end of said side wall and running parallel to said first groove member and spaced away from said first elongated groove member to permit snugly insertion of the plurality of spacers between said first and second groove members.

7. The rail system of claim 5 wherein each of said plurality of spacers comprises:
a top member; and
first and second parallel wings connected to said top member, said first and second wings shaped to be received in said grooves.

8. A rail system comprising:
a top and bottom rail;
a post adapted to receive said top and bottom rails;
a plurality of pickets for placement between said top and bottom rails; and
a plurality of spacers adapted to be inserted into said top and bottom rails for spacing said plurality of pickets apart.

9. The rail system of claim 8 wherein said top and bottom rails each comprise:
a substantially elongated planar member; and
first and second substantially parallel elongated side-walls perpendicularly connected to said planar member wherein said side walls each comprise opposing grooves running substantially parallel to said elongated planar member, said grooves adapted to receive the plurality of spacers.

10. The rail system claim 9 wherein each of said grooves comprises a first elongated groove member and a second elongated groove member, said first elongated groove member being connected adjacent an end of said side wall and extending perpendicularly from said side-wall, said second elongated groove member being connected adjacent said end of said side wall and running parallel to said first groove member and spaced away from said first elongated groove member to permit snugly insertion of the plurality of spacers between said first and second groove members.

11. The rail system of claim 9 wherein each of said plurality of spacers comprises:
a top member; and
first and second parallel wings connected to said top member, said first and second wings shaped to be received in said grooves.

12. The rail system claim 8 wherein said post further comprises an open ended head to receive the top rail.

13. The rail system of claim 8 wherein said post includes an opening for receiving the bottom rail

14. The rail system of claim 8 wherein the post further comprises connectors to receive the top and bottom rails.

15. The rail system of claim 16 wherein the connectors comprise universal angle brackets.

16. The rail system of claim 8 wherein the post further comprises post supports.
